(19) United States
(12) Patent Application Publication
(10) Pub. No.: US 2005/0101304 A1
(43) Pub. Date: May 12, 2005

(54) Mobile phone with auto-response capability

(76) Inventors: Meng-Ju Lin, Shalu Township (TW); Yu-Lan Lo, Yonghe City (TW)

Correspondence Address: SNELL & WILMER;ONE ARIZONA CENTER, 400 EAST VAN BUREN, PHOENIX, AZ, 850040001, US

(21) Appl. No.: 10/985,607

(22) Filed: Nov. 10, 2004

(30) Foreign Application Priority Data
Nov. 11, 2003 (TW) 92131514

(51) Int. Cl. H04M 1/00

(52) U.S. Cl. 455/413

(57) ABSTRACT

A mobile phone with auto-response capability is provided. The mobile phone includes a control module and a menu module. A memory stores a variety of response modes. The menu module is provided for setting a valid period to a first response mode which is selected by the control module. During the valid period, the control module answers an incoming call by the first response mode when the mobile phone doesn't establish a connection with the call.

### CROSS-REFERENCE TO RELATED APPLICATIONS

This application claims priority of Taiwan Patent Application Serial No. 092131514 filed on Nov. 11, 2003.

### FIELD OF INVENTION

The present invention relates to a mobile phone with auto-response capability and a method for a mobile phone to automatically respond to an incoming call.

### BACKGROUND OF THE INVENTION

Created to compensate drawbacks of conventional wired phones, mobile phones have become popular communication tools. Compared with wired phones, mobile phones are portable and able to provide communication and data-access almost anywhere. In other words, a mobile phone serves as a personal information proxy; that is, the user of the mobile phone can be reached as long as the mobile phone is connected with communication network. However, when the user does not answer an incoming call for some reason (e.g., the user is in a meeting), the user fails to convey any information to the caller of the incoming call.

A “voice mailbox” has become a fundamental function for almost all mobile phones. A caller can leave messages in the voice mailbox to the user of the mobile phone. Some mobile phones or some mobile phone systems allow the user to record his personal announcement for the voice mailbox. When the user does not answer the incoming call (i.e., the call connection is not established), the caller can know, by the announcement, the information or the status of the user, for example, the reason why the user does not answer the call, the time when the user will call back, etc. Also, incoming calls of different phone numbers can activate different announcements, by which specific information can be delivered to a specific caller. However, for mobile phones or mobile phone systems of the prior art, the user has to change the announcement manually as the user intends to alter his information or status.

Typically, a mobile phone moves with the user. In some situations, the user cannot answer a call, for example, when the user is in a meeting or at an outdoor activity. To overcome the drawbacks of prior art technology, it is desirable to have a mobile phone for performing different announcements in the voice mailbox based on the time the call comes in or a schedule. Furthermore, it will have more advantages if the mobile phone can automatically respond to specific information based on the phone number of incoming call.

### SUMMARY OF THE INVENTION

The main aspect of the present invention provides a mobile phone with auto-response capability and a method for a mobile phone to automatically respond to an incoming call. The mobile phone of the present invention achieves technical advantages as a personal information proxy. When the user does not answer an incoming call, the information or the status of user is delivered to the caller. In other words, the present invention provides a mobile phone that automatically responds to a caller's query about the information or the status of user. According to predetermined configurations, the caller knows the latest information or status of user despite the fact that the call connection is not established.

In one embodiment, a mobile phone includes an auto-response capability including a first memory, a control module, and a menu module. The first memory stores a plurality of response modes. A user uses the menu module to set a valid period corresponding to a first response mode. The control module is provided for selecting the first response mode from the plurality of response modes. During the valid period, the control module answers an incoming call by the first response mode when the user does not answer the incoming call.

In another embodiment, the mobile phone further includes a second memory for storing a schedule. The schedule has a plurality of time periods. The valid period is one of the plurality of time periods. When the current time falls within the valid period and when the mobile phone does not establish a connection with the incoming call, the control module answers the incoming call by the first response mode. Furthermore, the menu module further allows the mobile phone to input an event data corresponding to the valid period.

The invention also includes a method for a mobile phone to respond to an incoming call. The method includes: (a) storing a plurality of response modes; (b) selecting a first response mode from the plurality of response modes and setting a valid period for the first response mode; and (c) answering the incoming call, during the valid period, by the first response mode when the mobile phone does not establish the incoming call. The response modes can be implemented as (1) a voice record, (2) an event data played in an audio format, (3) a short message, or the like.

The foregoing and other features of the invention will be apparent from the following more particular description of embodiments of the invention.

### BRIEF DESCRIPTION OF THE DRAWINGS

The present invention is illustrated by way of example and not intended to be limited by the figures of the accompanying drawing.

FIG. 1 is a diagram of a mobile phone according to an embodiment of the present invention;

FIG. 2 is a diagram of a mobile phone network connected with a network according to another embodiment of the present invention;

FIG. 3 is a flowchart of a method according to an embodiment of the present invention; and

FIG. 4 is a flowchart of a method according to another embodiment of the present invention.

### DETAILED DESCRIPTION

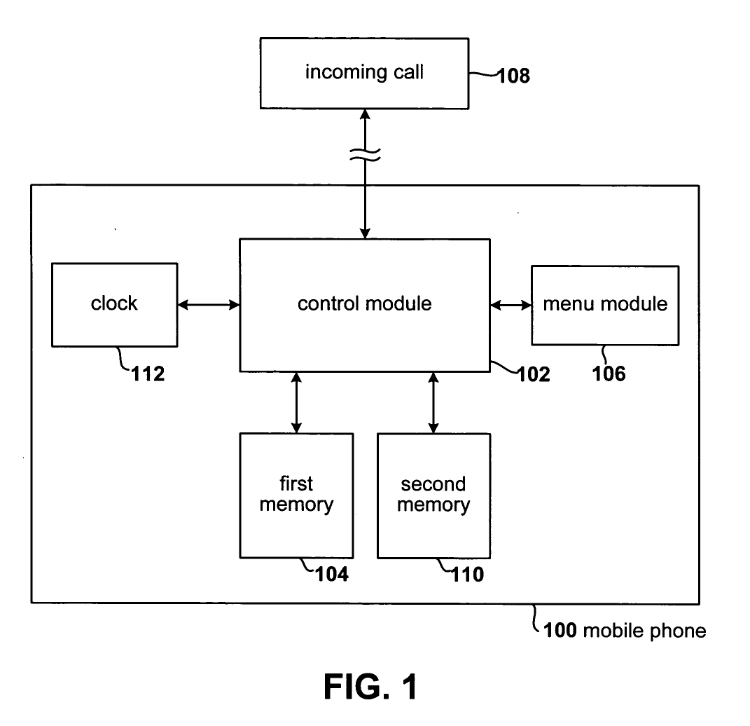

Referring to FIG. 1, the mobile phone 100 includes a control module 102, a first memory 104, and a menu module 106. The first memory 104 stores a plurality of response modes. A user uses the menu module 106 to set a valid period corresponding to a first response mode. The control module 102 is provided for selecting the first response mode from the plurality of response modes. During the valid period, the control module 102 answers an incoming call 108 by the selected first response mode when the user does not answer the incoming call 108 (that is, when the mobile phone 100 does not establish a connection with the incoming call 108).

In one embodiment, the first memory 104 further stores a plurality of voice records, and the first response mode corresponds to a first voice record. The first voice record is one of the plurality of voice records. During the valid period, the control module 102 answers the incoming call 108 by the first voice record when the mobile phone 100 does not establish the incoming call 108. For example, the user sets a period of “a meeting” corresponding to the first response mode. During the meeting, the control module 102 answers the incoming call by the first voice record, activated by the first response mode, when the user does not answer the incoming call 108. The voice record is recorded in advance to inform the caller of the status of user (e.g., in the meeting from 3 pm to 4 pm), the reason why the user does not answer the call, or the time when the user will call back.

In another embodiment, the first memory 104 further stores a plurality of short messages, and the first response mode corresponds to a first short message. The first short message is one of the plurality of short messages. During the valid period, the control module 102 answers the incoming call 108 by the first short message, activated by the first response mode, when the user does not answer the incoming call 108. The content of message is edited in advance, and the message is sent, based on the phone number of incoming call 108, to inform the caller of the status of user, the reason why the user does not answer the call, or the time when the user will call back.

The mobile phone further includes a second memory 110 and a clock 112. It should be note that the first memory 104 and the second memory 110 may be implemented as separate memory devices or as different sections of a same memory device. The second memory 110 is provided for storing a schedule having several event durations. Each event duration has a time period and an event data, such as information for reminding the user. The valid period is taken from one of the time periods. The clock 112 provides a current time. When the current time falls within the valid period and the mobile phone 100 does not establish the incoming call 108, the control module 102 answers the incoming call 108 by the first response mode.

In addition, the menu module 106 allows the mobile phone 100 to input an event data corresponding to the valid period. For example, in advance, the user inputs a first event data (e.g., a meeting) for a first valid period (e.g., from 3 pm to 4 pm) and a second event data (e.g., a speech) for a second valid period (e.g., from 5 pm to 6 pm). The first response mode is set to activate a first voice record, and the second response mode is set to activate a second voice record. When the current time falls within the first valid period (from 3 pm to 4 pm) and the user does not answer the incoming call 108, the control module 102 answers the incoming call 108 by the first voice record. The first voice record is recorded in advance to tell the caller that the user has a meeting, or the time the meeting will end. When the current time falls within the second valid period (from 5 pm to 6 pm) and the user does not answer the incoming call 108, the control module 102 answers the incoming call 108 by the second voice record. The second voice record is recorded in advance to tell the caller that the user is giving a speech, or the time when the speech will end. Thereby, the mobile phone 100 can automatically send different information to the caller even though the call is not established.

In one embodiment, the event data is recorded in a text format in the mobile phone 100. The event data is transmitted in form of a short message by the control module 102 according to the selected first response mode, and thus the caller at least gets the event data. In another embodiment, the event data is further transformed from the text format into a voice record, for example, using “Synthesized Voice” technology. When the users does not answer the incoming call 108, the control module 102 answers the incoming call 108, activated by the selected first response mode, by the voice record conveying the event data. The technology for transforming data from text format into voice record is well known to those skilled in the art and thus is omitted hereinafter. In still another embodiment, the event data is recorded in an audio format, for example, a piece of speech or a piece of music, and the selected first response mode plays the piece of speech or the piece of music to the caller.

The first memory 104 further stores multiple phone numbers, and the selected first response mode is activated only when the incoming call corresponds to one of the phone numbers. Moreover, for example, the control module 102 answers a incoming call by a first response mode when the incoming call corresponds to a first phone number, and the control module 102 answers the incoming call by a second response mode when the incoming call corresponds to a second phone number. Therefore, the control module 102 is able to play different voice records or to send different short messages to different callers. The technology to identify the phone numbers is well known to those skilled in the art and is also omitted hereinafter.

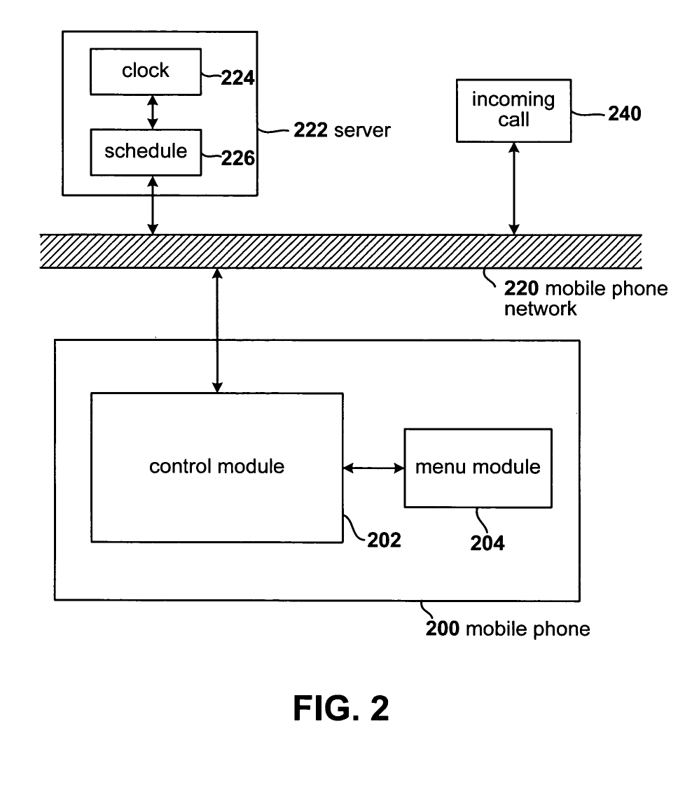

Referring to FIG. 2, a mobile phone 200 is linked to a server 222 via a mobile phone network 220. The server 222 stores a plurality of response modes and a schedule 226, and includes a clock 224 providing a current time. The mobile phone 200 includes a control module 202 and a menu module 204. The menu module 204 allows a user to set an event duration of the schedule 226 corresponding to a first response mode. The event duration includes a valid period and an event data. The control module 202 is provided for selecting the first response mode from those response modes. When the current time falls within the valid period and the mobile phone 200 does not establish an incoming call 240, the control module 202 transfers the incoming call 240 to the server 222 via the mobile phone network 220, and the server 222 responds to the diverted incoming call 240 by the first response mode selected by the control module 202. Furthermore, the sever 222 answers the incoming call 240 by the selected first response mode based on the phone number of the incoming call 240 and conveys specific event data to the specific caller. Similar to the mobile phone 100 in FIG. 1, the first response mode stored in the server 222 corresponds to a first voice record or a first short message.

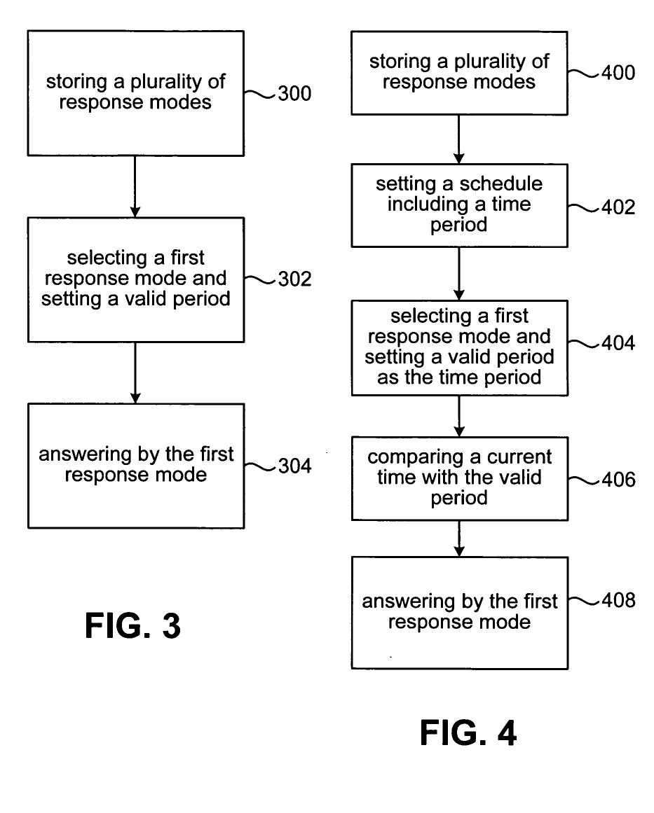

FIG. 3 is a flowchart of a method according to an embodiment of the present invention. It begins with the step 300 storing a plurality of response modes. Then in the step 302, a first response mode is selected from the plurality of response modes, and a valid period is set for the first response mode. Next, it turns to the step 304 answering the incoming call, during the valid period, by the first response mode when the mobile phone does not establish the incoming call.

Preferably, the plurality of response modes are stored in the mobile phone 100 in FIG. 1 or the server 222 in FIG. 2. When being stored in the mobile phone 100, the plurality of response modes can be pre-embedded in the mobile phone 100, downloaded from the network, or input into the mobile phone 100 by the user. In one embodiment, the first response mode selected in the step 302 is set as a default response mode for answering the incoming calls of all phone numbers. In another embodiment, the mobile phone 100 stores several phone numbers, and the first response mode is activated in step 304 only when the incoming call corresponds to one of the phone numbers.

FIG. 4 is a flowchart of a method according to another embodiment of the present invention. It begins with the step 400 storing a plurality of response modes. Each response mode has one corresponding valid period. Then the step 402 is to set a schedule including an event duration. In one embodiment, the event duration has a time period and an event data, for example, from 8 am to 9 am: a meeting. Step 402 is followed by the step 404 selecting a first response mode from those response modes stored in the step 400, and setting the valid period of the first response mode as the time period, that is, from 8 am to 9 am. In addition, the step 404 is to set the event duration corresponding to the first response mode which is, for example, to reply the event data. Next, the step 406 is to compare a current time with the valid period. The method ends with the step 408 answering the incoming call by the first response mode when the current time falls within the valid period (from 8 am to 9 am) and the mobile phone does not establish the incoming call.

While this invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A mobile phone with auto-response capability, comprising:
a first memory for storing a plurality of response modes;
a control module;
a menu module for setting a valid period corresponding to a first response mode, said first response mode selected by said control module from said plurality of response modes;
wherein, during said valid period, said control module answers an incoming call by said first response mode when said mobile phone does not establish a connection with said incoming call.

2. The mobile phone of claim 1, said first memory further storing a plurality of voice records, and said first response mode being corresponding to a first voice record, said first voice record being one of said voice records;
wherein, during said valid period, said control module answers said incoming call with said first voice record when said mobile phone does not establish a connection with said incoming call.

3. The mobile phone of claim 1, said first memory further storing a plurality of short messages, and said first response mode being corresponding to a first short message, said first short message being one of said short messages;
wherein, during said valid period, said control module answers said incoming call with said first short message when said mobile phone does not establish a connection with said incoming call.

4. The mobile phone of claim 1, further comprising:
a second memory for storing a schedule, said schedule having a plurality of time periods, said valid period being one of said time periods; and
a clock for providing a current time;
wherein, when said current time falls within said valid period, said control module answers said incoming call by said first response mode when said mobile phone does not establish a connection with said incoming call.

5. The mobile phone of claim 4, wherein said menu module further allows said mobile phone to input an event data corresponding to said valid period.

6. The mobile phone of claim 5, wherein said event data is recorded in a text format.

7. The mobile phone of claim 6, wherein said event data is transmitted in form of a short message activated by said first response mode.

8. The mobile phone of claim 6, wherein said event data is further transformed from said text format into a voice record activated by said first response mode.

9. The mobile phone of claim 5, wherein said event data is recorded in an audio format.

10. The mobile phone of claim 9, wherein said first response mode plays said event data in said audio format.

11. The mobile phone of claim 1, wherein said first memory further stores a phone number, wherein when said incoming call corresponds to said phone number, said control module answers said incoming call by said first response mode when said mobile phone does not establish a connection with said incoming call.

12. A mobile phone with auto-response capability, said mobile phone being linked to a server via a mobile phone network, said server comprising a schedule and a clock, said server storing a plurality of response modes, said clock providing a current time, said mobile phone comprising:
a menu module linking to said server, said menu module setting an event duration of said schedule corresponding to a first response mode, said event duration comprising a valid period and an event data; and
a control module linking to said server, said control module selecting said first response mode from said response modes;
wherein when said current time falls within said valid period and said mobile phone does not establish a connection with an incoming call, said control module transfers said incoming call to said server, and said server responds to said incoming call with said first response mode.

13. The mobile phone of claim 12, said server further storing a plurality of voice records, and said first response mode corresponding to a first voice record, said first voice record being one of said voice records;
wherein, during said valid period, said server answers said incoming call with said first voice record when said mobile phone does not establish a connection with said incoming call.

14. The mobile phone of claim 12, said server further storing a plurality of short messages, and said first response mode corresponding to a first short message, said first short message being one of said short messages;
wherein, during said valid period, said server answers said incoming call by said first short message when said mobile phone does not establish a connection with said incoming call.

15. A method for a mobile phone to respond to an incoming call, said method comprising:
(a) storing a plurality of response modes;
(b) selecting a first response mode from said plurality of response modes and setting a valid period for said first response mode; and
(c) answering said incoming call, during said valid period, with said first response mode when said mobile phone does not establish a connection with said incoming call.

16. The method of claim 15, further comprising:
(d) setting a schedule comprising an event duration, said event duration including a time period and an event data;
(e) setting said valid period as said time period, and setting said event duration corresponding to said first response mode;
(f) comparing a current time with said valid period; and
(g) answering said incoming call by said first response mode when said current time falls within said valid period and said mobile phone does not establish a connection with said incoming call.

17. The method of claim 16, further comprising:
setting first response mode as replying with said event data.

18. The method of claim 15, wherein the step (a) comprises:
storing said plurality of response modes in said mobile phone.

19. The method of claim 15, said mobile phone being linked to a mobile phone network, said mobile phone network comprising a server, wherein the step (a) comprises:
storing said plurality of response modes in said server.

20. The method of claim 15, wherein said first response mode is to activate a voice record.

21. The method of claim 15, wherein said first response mode is to activate a short message.

22. The method of claim 15, further comprising:
(h) storing a phone number;
wherein the step (c) comprises:
answering said incoming call by said first response mode when said incoming call corresponds to said phone number.
